(19) United States
(12) Patent Application Publication
(10) Pub. No.: US 2018/0252910 A1
(43) Pub. Date: Sep. 6, 2018

(54) OPTICAL FIBER SCANNER, ILLUMINATION DEVICE, AND OBSERVATION DEVICE

(71) Applicant: OLYMPUS CORPORATION, Tokyo (JP)

(72) Inventors: Hiroshi TSURUTA, Kanagawa (JP); Yasuaki KASAI, Saitama (JP); Hirokazu YOKOTA, Tokyo (JP)

(73) Assignee: OLYMPUS CORPORATION, Tokyo (JP)

(21) Appl. No.: 15/968,846

(22) Filed: May 2, 2018

Related U.S. Application Data
(63) Continuation of application No. PCT/JP2015/083533, filed on Nov. 30, 2015.

(51) Int. Cl. G02B 23/24; G02B 6/35; G02B 26/10; G01J 1/04; G01J 1/42

(52) U.S. Cl. CPC G02B 23/2469; G02B 6/3578; G02B 6/3566; G01J 1/42; G01J 1/0425; G01J 1/0403; G02B 26/103

(57) ABSTRACT

An optical fiber scanner including: an elongated optical fiber that guides light; a vibration transferring member that has a through-hole through which the optical fiber is made to pass; piezoelectric elements bonded to the outer surfaces of the vibration transferring member and that perform stretching vibrations in the longitudinal direction of the optical fiber when alternating voltages at a predetermined frequency are applied thereto, thus causing the optical fiber to generate bending vibrations in directions intersecting the longitudinal direction; and a fixing part that fixes the vibration transferring member. The vibration transferring member is provided with: holding surfaces formed of flat surfaces to which the piezoelectric elements are bonded; and contact surfaces formed of flat surfaces parallel to the holding surfaces, that are provided at least partially on the inner surfaces of the through-hole, and with which the outer surface of the optical fiber is brought into contact.

### CROSS-REFERENCE TO RELATED APPLICATIONS

This is a Continuation Application of International Application No. PCT/JP2015/083533 filed on Nov. 30, 2015. The content of International Application No. PCT/JP2015/083533 is hereby incorporated herein by reference in its entirety.

### TECHNICAL FIELD

The present invention relates to an optical fiber scanner, an illumination device, and an observation device.

### BACKGROUND ART

There is a known optical fiber scanner in which a cantilevered optical fiber is caused to perform bending vibrations by lead zirconate titanate (PZT) actuators (hereinafter, referred to as piezoelectric elements), thus scanning light emitted from the distal end of the cantilevered optical fiber (for example, see Japanese Unexamined Patent Application, Publication No. 2011-217835).

### SUMMARY OF INVENTION

One aspect of the present disclosure provides an optical fiber scanner including: an elongated optical fiber that guides light and emits the light from a distal end thereof; a vibration transferring member that is formed of an elastic member having a through-hole through which the optical fiber is made to pass at a position away from the distal end toward a proximal end thereof; a piezoelectric element that is bonded to an outer surface of the vibration transferring member, that performs stretching vibration in a longitudinal direction of the optical fiber when an alternating voltage at a predetermined frequency is applied thereto, and that causes, on the optical fiber, bending vibration in a direction intersecting the longitudinal direction; and a fixing part that fixes the vibration transferring member at a position closer to the proximal end than the piezoelectric element, wherein the vibration transferring member is provided with: a holding surface that is formed of a flat surface to which the piezoelectric element is bonded; and a contact surface that is formed of a flat surface parallel to the holding surface, that is provided at least partially on an inner surface of the through-hole, and with which an outer surface of the optical fiber is brought into contact.

### BRIEF DESCRIPTION OF DRAWINGS

FIG. 1 is a view showing the overall configuration of an observation device that is provided with an optical fiber scanner and an illumination device according to one embodiment of the present invention.

FIG. 2 is a perspective view showing the optical fiber scanner provided in the observation device shown in FIG. 1.

FIG. 3 is a front view showing the positional relationship among a ferrule, an optical fiber, and piezoelectric elements that are provided in the optical fiber scanner shown in FIG. 2, viewed from the distal end in the longitudinal-axis direction.

FIG. 4 is a partial transverse sectional view showing the positional relationship between a through-hole of the ferrule and the optical fiber shown in FIG. 3.

FIG. 5 is a partial transverse sectional view showing a comparative example of FIG. 3.

FIG. 6 is a partial transverse sectional view showing the comparative example in a state in which the optical fiber is shifted in position with respect to the ferrule from the state shown in FIG. 5.

### DESCRIPTION OF EMBODIMENTS

An optical fiber scanner 6, an illumination device 2, and an observation device 1 according to one embodiment of the present invention will be described below with reference to the drawings.

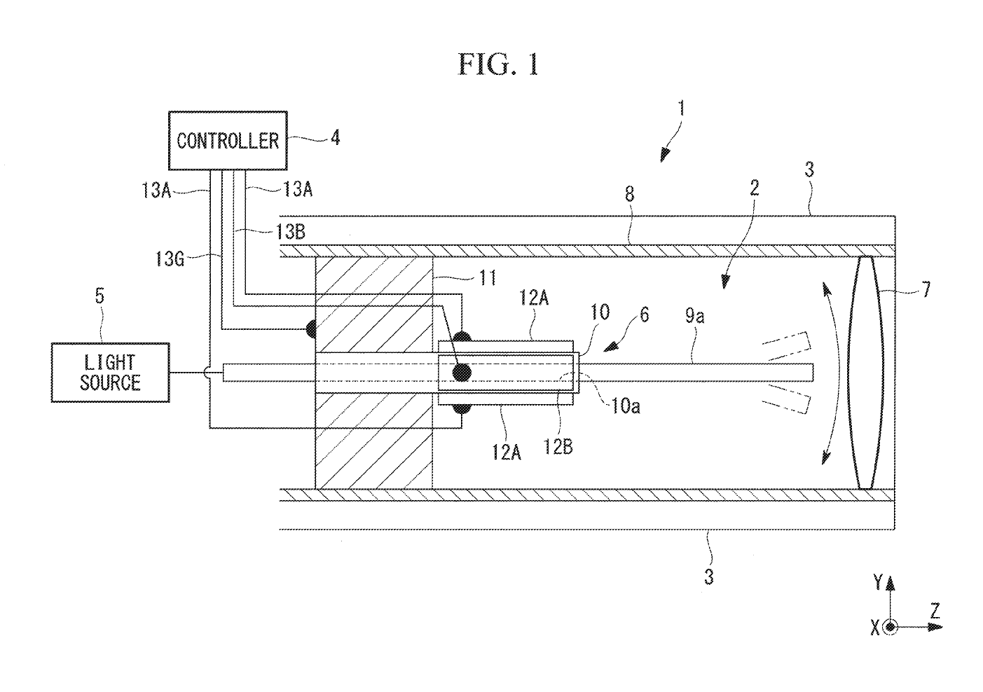

The observation device 1 of this embodiment is an endoscope device and, as shown in FIG. 1, is provided with: the illumination device 2 of the one embodiment of the present invention, which irradiates illumination light onto an object (not shown); light-receiving optical fibers (light detectors) 3 that receive return light from the object; and a controller (voltage supply unit) 4 that drivingly controls the illumination device 2.

The illumination device 2 of this embodiment is provided with: a light source 5; the optical fiber scanner 6, which scans light coming from the light source 5; a focusing lens 7 that is disposed at a position closer to the distal end than the optical fiber scanner 6 is and that focuses illumination light emitted from the optical fiber scanner 6; and an elongated cylindrical frame 8 that accommodates the optical fiber scanner 6 and the focusing lens 7.

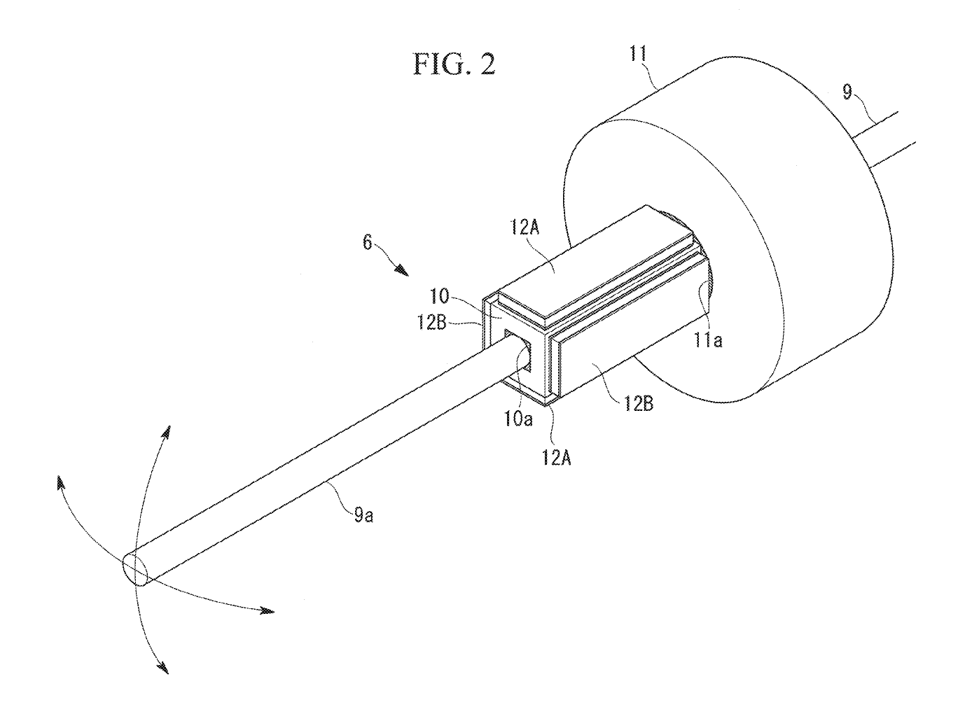

As shown in FIGS. 1 and 2, the optical fiber scanner 6 is provided with: an illumination optical fiber (optical fiber) 9, such as a multimode fiber or a single-mode fiber, that guides light from the light source 5 and that emits the light from the distal end thereof; a ferrule (vibration transferring member) 10 that has a through-hole 10a through which the illumination optical fiber 9 is made to pass and that is made of a square-tubular electrically-conductive elastic material; a cylindrical holder 11 that supports the ferrule 10; and four piezoelectric elements 12A and 12B that are fixed to outer surfaces of the ferrule 10. Lead wires 13A, 13B, and 13G for supplying alternating voltages are connected to the respective piezoelectric elements 12A and 12B and the holder 11. The light source 5 is connected to the proximal end of the illumination optical fiber 9.

The illumination optical fiber 9 is made of an elongated glass material having a circular shape in transverse section and is disposed along the longitudinal direction of the frame 8. The distal end of the illumination optical fiber 9 is disposed inside the frame 8 in the vicinity of the distal end of the frame 8. The proximal end of the illumination optical fiber 9 extends from the proximal end of the frame 8 toward the outside and is connected to the light source 5. Hereinafter, the longitudinal direction of the illumination optical fiber 9 is referred to as the Z-direction, and two radial directions of the illumination optical fiber 9 that are perpendicular to each other are referred to as the X-direction and the Y-direction.

The piezoelectric elements 12A and 12B each have a rectangular flat-plate shape and are made of a piezoelectric ceramic material, such as lead zirconate titanate (PZT), for example. In each of the piezoelectric elements 12A and 12B, a front surface is positively polarized, and a back surface is negatively polarized. Accordingly, the piezoelectric elements 12A and 12B are polarized in the plate-thickness direction from the positive pole to the negative pole, so that they have a feature of performing stretching vibrations (transverse effect) in a direction perpendicular to the polarization directions thereof when voltages are applied thereto.

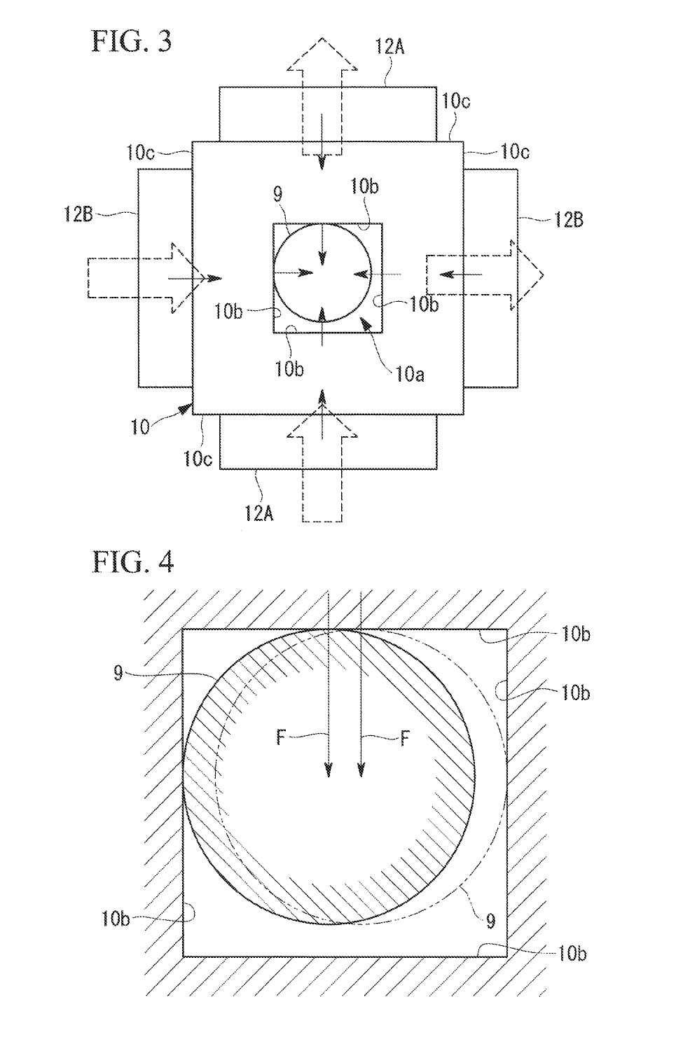

The four piezoelectric elements 12A and 12B are formed of two phase-A piezoelectric elements 12A and two phase-B piezoelectric elements 12B. As shown in FIG. 2, the phase-A piezoelectric elements 12A and the phase-B piezoelectric elements 12B are fixed to the four outer surfaces of the ferrule 10 by an adhesive agent. As shown in FIG. 3, the two phase-A piezoelectric elements 12A, which are opposed to each other in the Y-direction, are disposed such that the polarization directions thereof are directed in the same Y-direction, and the two phase-B piezoelectric elements 12B, which are opposed to each other in the X-direction, are disposed such that the polarization directions thereof are directed in the same X-direction. In FIG. 3, dotted arrows indicate the polarization directions.

In this embodiment, as shown in FIG. 2, the ferrule 10 is formed into a square tubular shape, and the through-hole 10a, which is located at the center and through which the illumination optical fiber 9 is made to pass, is square in cross section. Four flat inner surfaces (contact surfaces) 10b that constitute the through-hole 10a are respectively parallel to four flat outer surfaces (holding surfaces) 10c of the ferrule 10 to which the piezoelectric elements 12A and 12B are bonded. The spacing sizes between the two pairs of the inner surfaces 10b opposed to each other are set slightly larger than the diameter size of the illumination optical fiber 9, so that the illumination optical fiber 9 can be made to easily pass therethrough.

The holder 11 is a cylindrical electrically-conductive member having a central hole 11a and is fixed by an electrically conductive adhesive agent in a state in which a section of the ferrule 10 that is closer to the proximal end than the piezoelectric elements 12A and 12B are has been fitted into the central hole 11a. The outer circumferential surface of the holder 11 is fixed to the inner wall of the frame 8. Accordingly, the ferrule 10 is supported by the holder 11 in a cantilevered manner in which the distal end thereof serves as the free end, and a protruding section 9a of the illumination optical fiber 9 is supported by the ferrule 10 in a cantilevered manner in which the distal end thereof serves as the free end.

The holder 11 is electrically coupled, via the ferrule 10, to electrodes of the four piezoelectric elements 12A and 12B that are located on the sides of the ferrule 10, thus functioning as a common GND when the piezoelectric elements 12A and 12B are driven.

The phase-A lead wires 13A are bonded to the two phase-A piezoelectric elements 12A by an electrically conductive adhesive agent. The phase-B lead wires 13B are bonded to the two phase-B piezoelectric elements 12B by the electrically conductive adhesive agent. The GND lead wire 13G is bonded to the holder 11. The holder 11 has grooves (not shown) extending in the Z-direction that are formed at four positions spaced at intervals in the circumferential direction, so that the lead wires 13A and 13B are each accommodated in each of the grooves. The lead wires 13A and 13B and the GND lead wire 13G are connected to the controller 4.

The plurality of light-receiving optical fibers 3 are provided on the outer circumferential surface of the frame 8 by being arranged in the circumferential direction and guide return light (for example, reflected light of the illumination light or fluorescence) from the object to a photodetector (not shown).

The control unit 4 applies phase-A alternating voltages having a predetermined drive frequency to the phase-A piezoelectric elements 12A via the lead wires 13A and applies phase-B alternating voltages having the predetermined drive frequency to the phase-B piezoelectric elements 12B via the lead wires 13B. The predetermined drive frequency is set to be equal to the natural frequency of the protruding section 9a of the illumination optical fiber 9 or set to a frequency close thereto. The control unit 4 supplies the phase-A alternating voltages and the phase-B alternating voltages, whose phases differ by π/2 and whose amplitudes change in time sinusoidally, to the respective lead wires 13A and 13B.

The operation of the thus-configured optical fiber scanner 6, scanning-type illumination device 2, and scanning-type observation device 1 of this embodiment will be described below.

In order to observe an object by using the scanning-type observation device 1 of this embodiment, the controller 4 is actuated, causes illumination light to be supplied from the light source 5 to the illumination optical fiber 9, and applies alternating voltages having the predetermined drive frequency to the piezoelectric elements 12A and 12B via the lead wires 13A and 13B.

When the phase-A alternating voltages are applied, the phase-A piezoelectric elements 12A perform stretching vibrations in the Z-direction perpendicular to the polarization directions thereof. At this time, one of the two piezoelectric elements 12A contracts in the Z-direction, and the other expands in the Z-direction, thereby exciting, in the ferrule 10, Y-direction bending vibrations that have a node at the position of the holder 11. Then, the bending vibrations of the ferrule 10 are transferred to the illumination optical fiber 9, thereby causing the protruding section 9a to perform bending vibrations in the Y-direction at a frequency equivalent to the drive frequency of the alternating voltages, causing the distal end of the illumination optical fiber 9 to vibrate in the Y-direction, and causing illumination light emitted from the distal end to be linearly scanned in the Y-direction.

When the phase-B alternating voltages are applied, the phase-B piezoelectric elements 12B perform stretching vibrations in the Z-direction perpendicular to the polarization directions thereof. At this time, one of the two piezoelectric elements 12B contracts in the Z-direction, and the other expands in the Z-direction, thereby exciting, in the ferrule 10, X-direction bending vibrations that have a node at the position of the holder 11. Then, the bending vibrations of the ferrule 10 are transferred to the illumination optical fiber 9, thereby causing the protruding section 9a to perform bending vibrations in the X-direction at a frequency equivalent to the drive frequency of the alternating voltages, and causing illumination light emitted from the distal end to be linearly scanned in the X-direction.

Here, the phase of the phase-A alternating voltage and the phase of the phase-B alternating voltage are shifted by π/2, and the amplitudes of the phase-A alternating voltage and the phase-B alternating voltage change in time sinusoidally; thus, the distal end of the illumination optical fiber 9 vibrates along a spiral trajectory, and the illumination light is two-dimensionally scanned over the object along the spiral trajectory. Furthermore, because the drive frequency is set to be equal to the natural frequency of the protruding section 9a or set to a frequency close thereto, the protruding section 9a can be efficiently excited.

Return light from the object is received by the plurality of light-receiving optical fibers 3, and the intensity thereof is detected by the photodetector. The controller 4 causes the return light, which returns to the photodetector in synchronization with the scanning period of the illumination light, to be detected and associates the intensity of the detected return light with the scanning position of the illumination light, thereby generating an image of the object.

In this case, according to this embodiment, the through-hole 10a of the ferrule 10 is formed to into a square shape in cross section, and the four inner surfaces 10b of the through-hole 10a are formed to be parallel to the four outer surfaces 10c of the ferrule 10, respectively. Therefore, as shown in FIG. 4, even when the illumination optical fiber 9, which is made to pass through the through-hole 10a and which is circular in transverse section, moves in a direction perpendicular to the longitudinal axis due to a backlash in the through-hole 10a, there is an advantage in that the direction of a force F transferred from each of the piezoelectric elements 12A and 12B to the illumination optical fiber 9 is not changed.

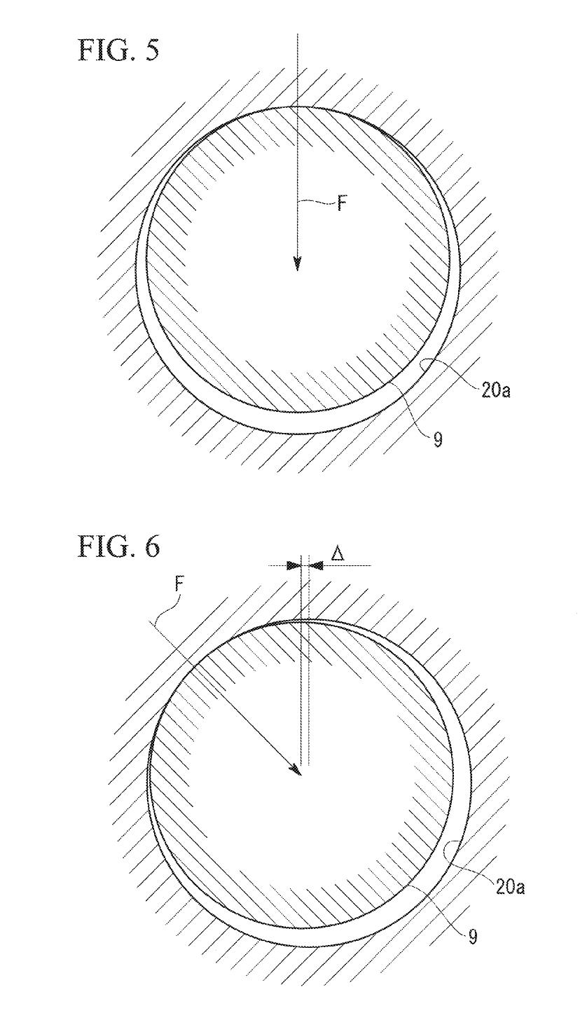

In contrast to this, in a case in which a through-hole 20a of a ferrule 20 is circle, as shown in FIGS. 5 and 6 as comparative examples, even when the illumination optical fiber 9 moves, in the through-hole 20a, by an extremely minute distance Δ in a direction perpendicular to the longitudinal axis, the direction of the normal line at the contact position of the through-hole 20a and the illumination optical fiber 9 significantly changes. As a result, there is a disadvantage in that the direction of the force F transferred from the piezoelectric elements 12A and 12B to the illumination optical fiber 9 significantly changes.

According to this embodiment, even if there is a backlash between the through-hole 10a of the ferrule 10 and the illumination optical fiber 9, because the direction of the vibrations transferred from the piezoelectric elements 12A and 12B to the illumination optical fiber 9 via the ferrule 10 does not change, there is an advantage in that vibrations of the piezoelectric elements 12A and 12B are easily controlled, and the distal end of the illumination optical fiber 9 can be accurately vibrated along a desired trajectory.

Note that, in this embodiment, the ferrule 10 is formed into a square tubular shape; however, instead of this, the ferrule 10 may be formed into a triangular tubular shape or tubular shape with five or more corners. With this configuration, the piezoelectric elements 12A and 12B are bonded on the outer surfaces 10c parallel to the inner surfaces 10b of the through-hole 10a, thereby making it possible to transfer the vibrations to the illumination optical fiber 9 without changing the direction of the vibrations from the piezoelectric elements 12A and 12B.

Furthermore, the cross-sectional shape of the central hole 11a of the holder 11, through which the ferrule 10 is made to pass, may be quadrangular, instead of circular.

From the above-described embodiments, the following aspects of the present disclosure are derived.

One aspect of the present disclosure provides an optical fiber scanner including: an elongated optical fiber that guides light and emits the light from a distal end thereof; a vibration transferring member that is formed of an elastic member having a through-hole through which the optical fiber is made to pass at a position away from the distal end toward a proximal end thereof; a piezoelectric element that is bonded to an outer surface of the vibration transferring member, that performs stretching vibration in a longitudinal direction of the optical fiber when an alternating voltage at a predetermined frequency is applied thereto, and that causes, on the optical fiber, bending vibration in a direction intersecting the longitudinal direction; and a fixing part that fixes the vibration transferring member at a position closer to the proximal end than the piezoelectric element, wherein the vibration transferring member is provided with: a holding surface that is formed of a flat surface to which the piezoelectric element is bonded; and a contact surface that is formed of a flat surface parallel to the holding surface, that is provided at least partially on an inner surface of the through-hole, and with which an outer surface of the optical fiber is brought into contact.

According to this aspect, when an alternating voltage is applied to the piezoelectric element in a state in which the proximal end portion of the vibration transferring member has been fixed via the fixing part, bending vibrations that have a frequency equal to the frequency of the alternating voltage and that have a node at the position of the fixing part are generated in the vibration transferring member, and the bending vibrations are transferred to the optical fiber. Because a section of the optical fiber that is closer to the distal end than the vibration transferring member is supported by the vibration transferring member in a cantilevered manner in which the distal end thereof serves as the free end, the distal end of the optical fiber is vibrated in directions intersecting the longitudinal direction by the bending vibrations transferred from the vibration transferring member, and light emitted from the distal end of the optical fiber is scanned in directions intersecting the traveling direction of the light.

In this case, because the holding surface of the vibration transferring member, to which the piezoelectric element is bonded, and the contact surface inside the through-hole of the vibration transferring member, with which the optical fiber is brought into contact, are provided so as to be parallel, even if there is a gap (backlash) between the optical fiber and the through-hole, thus allowing the optical fiber to move toward the gap, the optical fiber is brought into contact with any section of the contact surface, thereby avoiding a change in the direction of the vibrations transferred from the piezoelectric element.

Specifically, even when the optical fiber is brought into contact with the contact surface at any position in the direction of the gap, because the direction of the force transferred from the piezoelectric element to the optical fiber is not changed, it is possible to stabilize the vibration state of the optical fiber.

In the above-described aspect, the vibration transferring member may be formed of a polygonal tube provided with a plurality of holding surfaces that are arranged in a circumferential direction and a plurality of contact surfaces that are respectively parallel to the holding surfaces.

By doing so, because the through-hole, which is provided in the vibration transferring member, is also formed into a polygonal shape that is similar to the outer shape of the vibration transferring member, when the optical fiber is placed and bonded so as to be simultaneously brought into contact with two adjacent contact surfaces, the directions of vibrations transferred to the optical fiber from two piezoelectric elements are not changed. Accordingly, the vibration state of the optical fiber can be stabilized.

Furthermore, in the above-described aspect, the vibration transferring member may be a square tube.

Furthermore, according to another aspect, the present invention provides an illumination device including: a light source that produces illumination light; and any of the above-described optical fiber scanners, which scans the illumination light from the light source.

Furthermore, according to still another aspect, the present invention provides an observation device including: the above-described illumination device; a light detector that detects return light from an object when illumination light from the illumination device is irradiated onto the object; and a voltage supply unit that supplies an alternating voltage at the predetermined frequency to the piezoelectric element.

According to the present disclosure, an advantageous effect is afforded in that the vibration state of an optical fiber can be stabilized by precisely disposing the optical fiber with respect to piezoelectric elements.

### REFERENCE SIGNS LIST

1 observation device
2 illumination device
3 light-receiving optical fiber (light detector)
4 voltage supply unit (controller)
5 light source
6 optical fiber scanner
9 illumination optical fiber (optical fiber)
10 ferrule (vibration transferring member)
10a through-hole
10b inner surface (contact surface)
10c outer surface (holding surface)
11 holder (fixing part)
12A, 12B piezoelectric element

1. An optical fiber scanner comprising:
an elongated optical fiber that guides light and emits the light from a distal end thereof;
a vibration transferring member that is formed of an elastic member having a through-hole through which the optical fiber is made to pass at a position away from the distal end toward a proximal end thereof;
a piezoelectric element that is bonded to an outer surface of the vibration transferring member, that performs stretching vibration in a longitudinal direction of the optical fiber when an alternating voltage at a predetermined frequency is applied thereto, and that causes, on the optical fiber, bending vibration in a direction intersecting the longitudinal direction; and
a fixing part that fixes the vibration transferring member at a position closer to the proximal end than the piezoelectric element,
wherein the vibration transferring member is provided with: a holding surface that is formed of a flat surface to which the piezoelectric element is bonded; and a contact surface that is formed of a flat surface parallel to the holding surface, that is provided at least partially on an inner surface of the through-hole, and with which an outer surface of the optical fiber is brought into contact.

2. An optical fiber scanner according to claim 1, wherein the vibration transferring member is formed of a polygonal tube provided with a plurality of holding surfaces that are arranged in a circumferential direction and a plurality of contact surfaces that are respectively parallel to the holding surfaces.

3. An optical fiber scanner according to claim 2, wherein the vibration transferring member is a square tube.

4. An illumination device comprising:
a light source that produces illumination light; and
an optical fiber scanner according to claim 1 that scans the illumination light from the light source.

5. An observation device comprising:
an illumination device according to claim 4;
a light detector that detects return light from an object when illumination light from the illumination device is irradiated onto the object; and
a voltage supply unit that supplies an alternating voltage at the predetermined frequency to the piezoelectric element.
